(19) United States
(12) Patent Application Publication
(10) Pub. No.: US 2008/0008453 A1
(43) Pub. Date: Jan. 10, 2008

(54) Image Processing Apparatus

(75) Inventor: Junya Kaku, Hyogo (JP)

Correspondence Address: KRATZ, QUINTOS & HANSON, LLP, 1420 K Street, N.W., Suite 400, WASHINGTON, DC, 20005, US

(73) Assignee: SANYO ELECTRIC CO., LTD., MORIGUCHI-SHI, OSAKA (JP)

(21) Appl. No.: 11/596,673

(22) PCT Filed: Apr. 18, 2005
(86) PCT No.: PCT/JP05/07750

§ 371 Date: Nov. 16, 2006

(30) Foreign Application Priority Data
May 17, 2004 (JP) 2004-146162

(51) Int. Cl. H04N 7/26

(52) U.S. Cl. 386/109

(57) ABSTRACT

Each of a plurality of GOPs includes a plurality of frames of image data in which a start frame in a forward direction is subjected to intra-encoding and a frame successive to the start frame in the forward direction is subjected to inter-encoding. A CPU (36) designates the plurality of GOP blocks in a reverse direction. An MPEG 4 codec (38) decodes the plurality of frames of the image data included in the designated GOP in a forward direction, and a JPEG codec (40) performs intra-encoding on the plurality of frames of the decoded image data in the forward direction. The CPU (36) determines whether or not the number of frames on which the intra-encoding is performed is equal to or more than a threshold value. The JPEG codec (40) decodes in the reverse direction the plurality of frames of the image data on which intra-encoding is performed when the determination result by the CPU (36) is affirmative.

### TECHNICAL FIELD

The present invention relates to an image processing apparatus. More specifically, the present invention relates to an image processing apparatus for processing a plurality of screens of image data including intra-encoded screens and inter-encoded screens.

### PRIOR ART

An example of such a kind of conventional apparatus is disclosed in a Japanese Patent Laying-open No. 2003-52020 disclosed on Feb. 21, 2003. According to the prior art when a reverse reproduction is instructed, B pictures and P pictures forming an MPEG video stream are decoded along a forward direction (first-time-axis direction), the decoded image data are encoded again into the B pictures along the reverse direction (second-time-axis direction), and a re-encoded data string comprising the I pictures forming the MPEG video stream and the reencoded B pictures are generated. An MPEG video decoder decodes the reencoded data string thus generated in the reverse direction, and outputs the decoded image data to a display circuit. This allows a smooth reverse reproduction. However, in the prior art, two MPEG decoders have to be prepared, causing a problem of increasing a circuit dimension.

### SUMMARY OF THE INVENTION

Therefore, it is a primary object of the present invention to provide a novel image processing apparatus.

Another object of the present invention is to provide an image processing apparatus capable of reproducing along a second-time-axis direction reverse to a first-time-axis direction image data of a plurality of screens on which intra-encoding and inter-encoding are performed along the first-time-axis direction while reducing a circuit dimension.

According to claim 1, an image processing apparatus comprises a designating means for designating a plurality of blocks each including a plurality screen of image data in which a top screen in a first-time-axis direction is subjected to intra-encoding and a screen successive to the top screen in the first-time-axis direction is subjected to inter-encoding in turn along a second-time-axis direction reverse to the first-time-axis direction, a first decoding means for decoding the plurality of screens of image data included in the block designated by the designating means in turn along the first-time-axis direction, an encoding means for performing intra-encoding along the first-time-axis direction on each of the plurality of screens of the image data decoded by the first decoding means, and a second decoding means for decoding the plurality of screens of the image data encoded by the encoding means in turn along the second-time-axis direction.

Each of a plurality of blocks includes a plurality of screens of image data in which a top screen in a first-time-axis direction is subjected to intra-encoding, and a screen successive to the top screen in the first-time-axis direction is subjected to inter-encoding. A designating means designates the plurality of blocks in turn along a second-time-axis direction reverse to the first-time-axis direction. A first decoding means decodes the plurality screen of image data included in the designated block in turn along the first-time-axis direction, and an encoding means performs intra-encoding along the first-time-axis direction on each of the plurality of screens of the decoded image data. The plurality of screens of the encoded image data is decoded by a second decoding means along the second-time-axis direction.

That is, the image data decoded in the first-time-axis direction by the first decoding means is subjected to intra-encoding in the first-time-axis direction by the encoding means. The image data to which the intra-encoding is performed is then decoded along the second-time-axis direction by the second decoding means. Employing the intra-encoding allows reproduction of the image data along the second-time-axis direction while reducing a circuit dimension.

According to claim 2 dependent on claim 1, an image processing apparatus further comprises a determining means for determining whether or not the number of screens on which the intra-encoding is performed is equal to or more than a threshold value, and the second decoding means performs a decoding process when a determination result by the determining means is affirmative.

The intra-encoding processing of the image data is executed along the first-time-axis direction while the decoding processing of the image data on which the intra-encoding has been performed is executed along the second-time-axis direction. Here, in claim 2, it is determined whether or not the number of the screens on which the intra-encoding is performed is above a threshold value, and when the determination result is affirmative, a decoding process is executed. Thus, it is possible to prevent a failure of the processing.

According to claim 3 depending on claim 1 or 2, each of the encoding means and the second decoding means comply with a JPEG system.

According to claim 4 depending on any one of claims 1 to 3, the first-time-axis direction is a forward direction, and the second-time-axis direction is a reverse direction.

According to claim 5, an image processing program executed by a processor of an image processing apparatus, comprises a designating step for designating a plurality of blocks each including a plurality screen of image data in which a top screen in a first-time-axis direction is subjected to intra-encoding and a screen successive to the top screen in the first-time-axis direction is subjected to inter-encoding in turn along a second-time-axis direction reverse to the first-time-axis direction, a first decoding step for decoding the plurality of screens of image data included in the block designated by the designating step in turn along the first-time-axis direction, an encoding step for performing intra-encoding along the first-time-axis direction on each of the plurality of screens of the image data decoded by the first decoding step, and a second decoding step for decoding the plurality of screens of the image data encoded by the encoding step in turn along the second-time-axis direction.

Similarly to claim 1, the image data decoded in the first-time-axis direction by the first decoding step is subjected to the intra-encoding by the encoding step in the first-time-axis direction. The image data on which the intra-encoding is performed is then decoded by the second decoding step in the second-time-axis direction. Employing the intra-encoding allows reproduction of the image data in the second-time-axis direction while reducing a circuit dimension.

According to claim 6, an image processing apparatus comprises a processor for designating a plurality of blocks each including a plurality screen of image data in which a top screen in a first-time-axis direction is subjected to intra-encoding and a screen successive to the top screen in the first-time-axis direction is subjected to inter-encoding in turn along a second-time-axis direction reverse to the first-time-axis direction, a decoder for decoding the plurality of screens of the image data included in the block designated by the processor in turn along the first-time-axis direction, and a codec for performing intra-encoding along the first-time-axis direction on each of the plurality of screen of the image data decoded by the decoder, and decoding the plurality of screens of the image data on which the intra-encoding is performed in turn along the second-time-axis direction.

Each of a plurality of blocks includes a plurality of screens of image data in which a top screen is subjected to intra-encoding in a first-time-axis direction and the screen successive to the top screen in the first-time-axis direction subjected to inter-encoding. A processor designates the plurality of blocks in a second-time-axis direction reverse to the first-time-axis direction. The decoder decodes the plurality of screens of the image data included in the designated block in turn along the first-time-axis direction. The codec performs intra-encoding along the first-time-axis direction on the plurality of screen of the decoded image data, and decodes the plurality of screens of the encoded image data in turn along the second-time-axis direction.

Similarly to claims 1 or 5, it is possible to reproduce the image data in the second-time-axis direction while reducing a circuit dimension.

According to claim 7 depending on claim 6, the processor alternately instructs the codec to perform an encoding process and a decoding process, and the codec executes a process according to an instruction from the processor.

The above described objects and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram showing one example of a configuration of one embodiment of the present invention;

FIG. 2 is an illustrative view showing one example of a mapping state of an SDRAM applied to FIG. 1 embodiment;

FIG. 3 is an illustrative view showing a part of an operation of FIG. 1 embodiment;

FIG. 4 is an. illustrative view showing another part of the operation of FIG. 1 embodiment;

FIG. 5 (A) is an illustrative view showing another part of an operation of FIG. 1 embodiment;

FIG. 5 (B) is an illustrative view showing the other part of the operation of FIG. 1 embodiment;

FIG. 5 (C) is an illustrative view showing a further part of the operation of FIG. 1 embodiment;

FIG. 5 (D) is an illustrative view showing another part of the operation of FIG. 1 embodiment;

FIG. 6 is a flowchart showing a part of an operation by a CPU applied to FIG. 1 embodiment;

FIG. 7 is a flowchart showing another part of the operation by the CPU applied to FIG. 1 embodiment;

FIG. 8 is a flowchart showing the other part of the operation by the CPU applied to FIG. 1 embodiment;

FIG. 9 is a flowchart showing a further part of the operation by the CPU applied to FIG. 1 embodiment;

FIG. 10 is a flowchart showing another part of the operation by the CPU applied to FIG. 1 embodiment;

FIG. 11 is a flowchart showing the other part of the operation by the CPU applied to FIG. 1 embodiment; and

FIG. 12 is a flowchart showing a further part of the operation by the CPU applied to FIG. 1 embodiment.

### BEST MODE FOR PRACTICING THE INVENTION

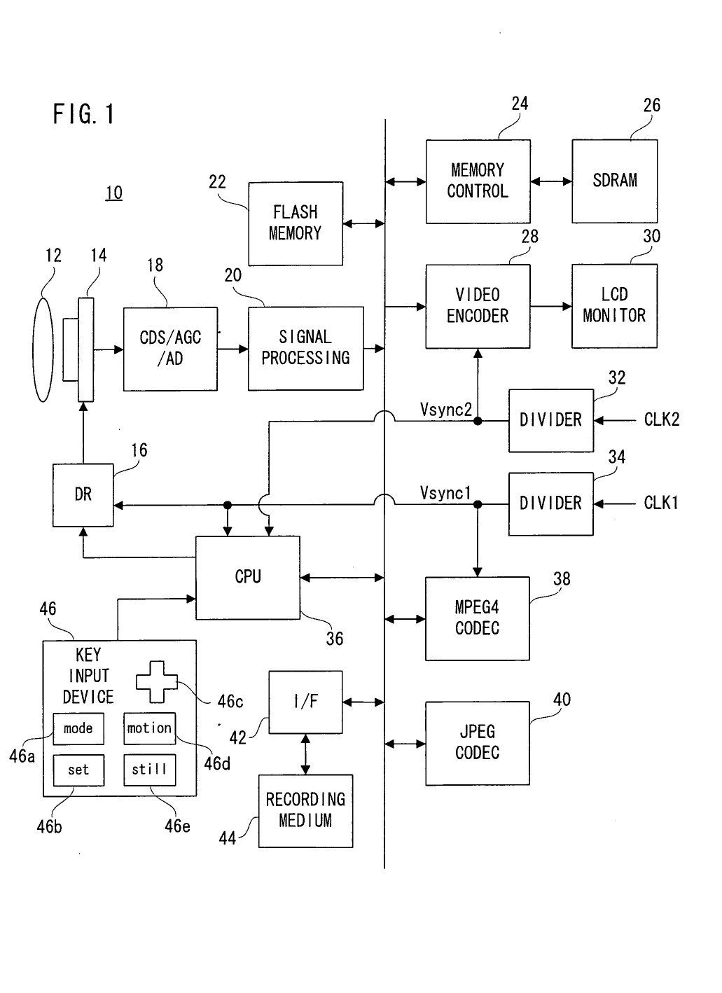

With reference to FIG. 1, a digital video camera 10 of this embodiment includes an optical lens 12. An optical image of an object scene is irradiated to an imaging surface of an image sensor 14 through the optical lens 12. On the imaging surface, electric charges corresponding to the optical image of the object scene, that is, raw image signal is generated by a photoelectronic conversion.

When a camera mode is selected by a mode key 46a provided on a key input device 46, a through image processing, that is, processing of displaying a real-time motion image of the object scene on an LCD monitor 30 is executed. A CPU 36 first instructs a driver 16 to repeat a pre-exposure and thinning-out reading. The driver 16 repeatedly executes a pre-exposure of the image sensor 14 and a thinning-out reading of the raw image signal thus generated. The pre-exposure and thinning-out reading are executed in response to a vertical synchronization signal Vsync 1 output from a frequency divider 34 on the basis of a clock CLK1. The vertical synchronization signal Vsync 1 is generated per 1/30 seconds, and thus, a low-resolution raw image signal in correspondence to the optical image of the object scene is output from the image sensor 14 at a frame rate of 30 fps.

The output raw image signal of each frame is subjected to a series of processes, such as a noise removal, a level adjustment, and an A/D conversion by a CDS/AGC/AD circuit 18 to thereby generate raw image data of a digital signal. A signal processing circuit 20 performs processes, such as a white balance adjustment, a color separation, a YUV conversion on the raw image data output from the CDS/AGC/AD circuit 18 to generate image data in YUV format. The generated each frame of image data is written to an SDRAM 26 by a memory control circuit 24.

A video encoder 28 requests the memory control circuit 24 to read the image data in response to a vertical synchronization signal Vsync 2 output from a frequency divider 32 on the basis of the clock CLK2. The vertical synchronization signal Vsync 2 is also generated per 1/30 seconds, and thus, the image data is transferred to the video encoder 28 from the SDRAM 26 at a frame rate of 30 fps.

The video encoder 28 converts the transferred image data into a composite video signal in the NTSC format, and applies the converted composite video signal to the LCD monitor 30. Consequently, a through-image of the object scene is displayed on the monitor screen. It should be noted that although the description is appropriately omitted below, access to the SDRAM 26 is sure to be performed through the memory control circuit 24.

When a still image shooting key 46e is operated, the CPU 36 instructs the driver 16 to perform one-time primary exposure and one-time all-pixel reading. The driver 16 executes once a primary exposure of the image sensor 14 and all-pixel reading of the raw image signal thus generated. Thus, a high-resolution raw image signal corresponding to the optical image of the object scene is output from the image sensor 14. The output raw image signal is converted into still image data in YUV format by the process described above, and the converted still image data is written to the SDRAM 26.

The CPU 36 issues a compression instruction to a JPEG codec 40. The JPEG codec 40 reads the still image data from the SDRAM 26, performs a JPEG compression on the read still image data, and writes the compressed still image data, that is, the JPEG data to the SDRAM 26. The CPU 36 then reads the JPEG data from the SDRAM 26, and records a JPEG file including the read JPEG data onto a recording medium 44 through an I/F 42.

It should be noted the recording medium 44, which is a detachable semiconductor memory, is accessible by the I/F 42 when being attached to a slot not shown.

When a motion image shooting key 46d is operated in a state that the through-image is displayed on the LCD monitor 30, the CPU 36 activates an MPEG 4 codec 34. The MPEG 4 codec 34 reads each frame of image data from the SDRAM 26 every time that a vertical synchronization signal Vsync 1 is generated, and performs a compression processing on the read image data according to a simple profile in the MPEG4 format. The image data is subjected to intra-encoding per 15 frames, and is subjected to inter-encoding in the rest of the frame. The compressed motion image data thus generated, that is, the MPEG data is written to the SDRAM 26.

The intra-encoded frame shall be defined as “I frame”, and the inter-encoded frame shall be defined as “P frame”. Furthermore, a group including the I frame and a plurality of successive P frames is defined as “GOP (Group Of Pictures)”. Here, the MPEG data has a data structure shown in FIG. 3. The identification number starting from “0” is assigned to each of the GOPs.

The CPU 40 periodically reads the MPEG data accumulated in the SDRAM 26, and records the read MPEG data onto the recording medium 44 through the I/F 42. When the motion image shooting key 46d is operated again, the CPU 36 disables the MPEG 4 codec 38, and records the MPEG data remaining in the SDRAM 26 onto the recording medium 44. The MPEG file including a plurality of frames of MPEG data is created onto the recording medium 44.

When a reproduction mode is selected by the mode key 46a, and a desired JPEG file is selected by the cursor key 46c and the set key 46b, the CPU 36 transfers the JPEG data stored in the JPEG file from the recording medium 44 to the SDRAM 26, and applies an expansion instruction to the JPEG codec 40. The JPEG codec 40 reads the JPEG data from the SDRAM 26, expands the read JPEG data, and writes the expanded image data to the SDRAM 26. The video encoder 28 reads the image data from the SDRAM 26 every time that a vertical synchronization signal Vsync 2 is generated, converts the read image data into a composite video signal in the NTSC format, and applies the converted composite video signal to the LCD monitor 30. Thus, a still image is displayed on the LCD monitor 30.

When a desired MPEG file is selected by the cursor key 46c and set key 46b in a state that the reproduction mode is selected, a reproduction process of the MPEG file is executed. The CPU 36 first transfers a first frame of MPEG data stored in the MPEG file to the SDRAM 26 from the recording medium 44, and applies an expansion instruction to the MPEG 4 codec 38. The MPEG codec 38 reads the first frame of MPEG data from the SDRAM 26, expands the read MPEG data, and then writes the expanded image data to the SDRAM 26. The video encoder 28 executes the above-described process to thus display a still image of the first frame on the LCD monitor 30.

Here, when the set key 46b is operated again, a motion image reproduction is executed. The CPU 36 transfers the MPEG data stored in a desired MPEG file in a cycle of one GOP to the SDRAM 26 by one GOP, and applies an expansion instruction to the MPEG 4 codec 38 in response to a vertical synchronization signal Vsync 1. The MPEG 4 codec 38 executes the above-described process in response to a vertical synchronization signal Vsync 1. The video encoder 28 reads image data from the SDRAM 26 every time that a vertical synchronization signal Vsync 2 is generated, converts the read image data into a composite video signal in the NTSC format, and then applies the converted composite video signal to the LCD monitor 30. Consequently, a motion image successive to the first frame is displayed on the LCD monitor 30.

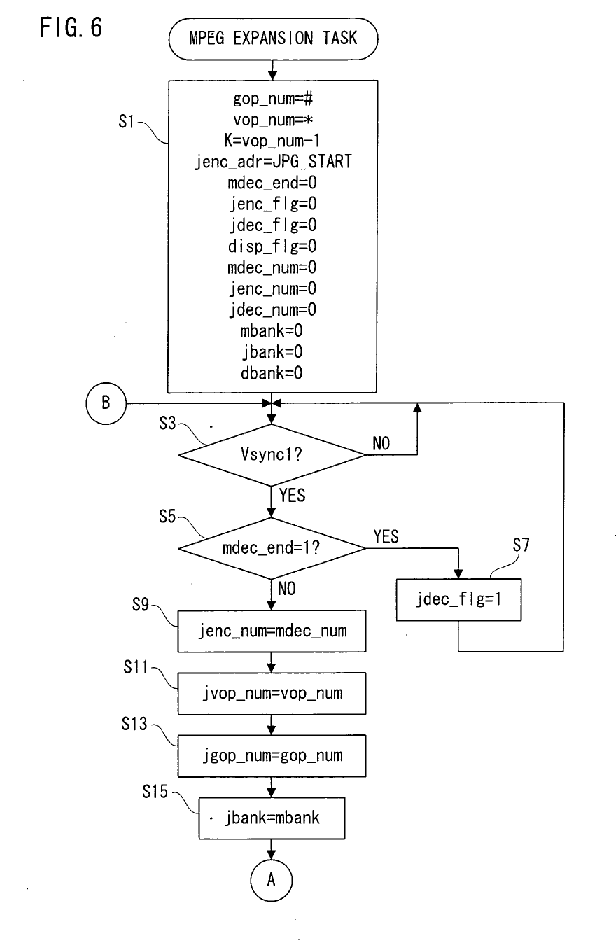

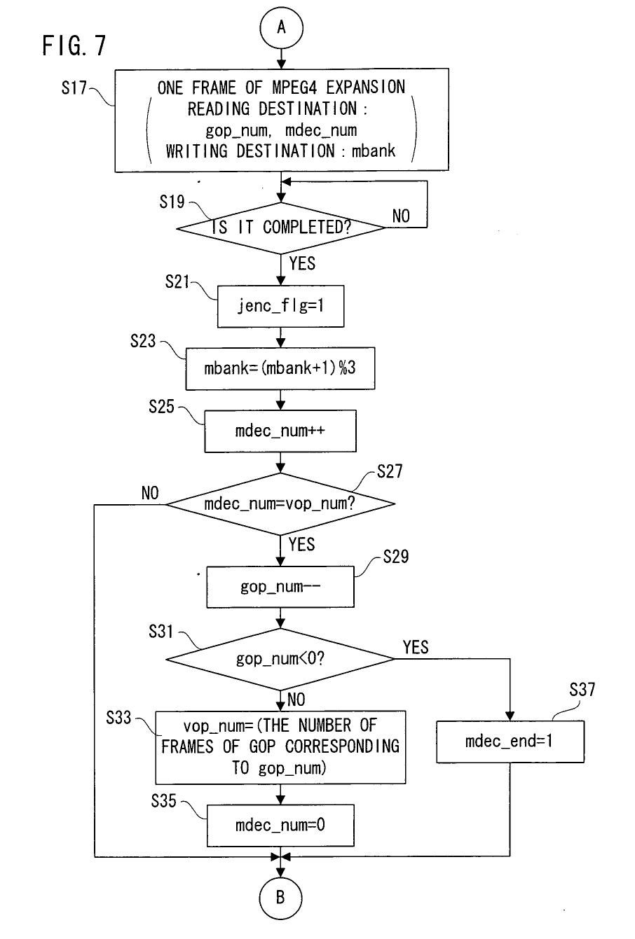

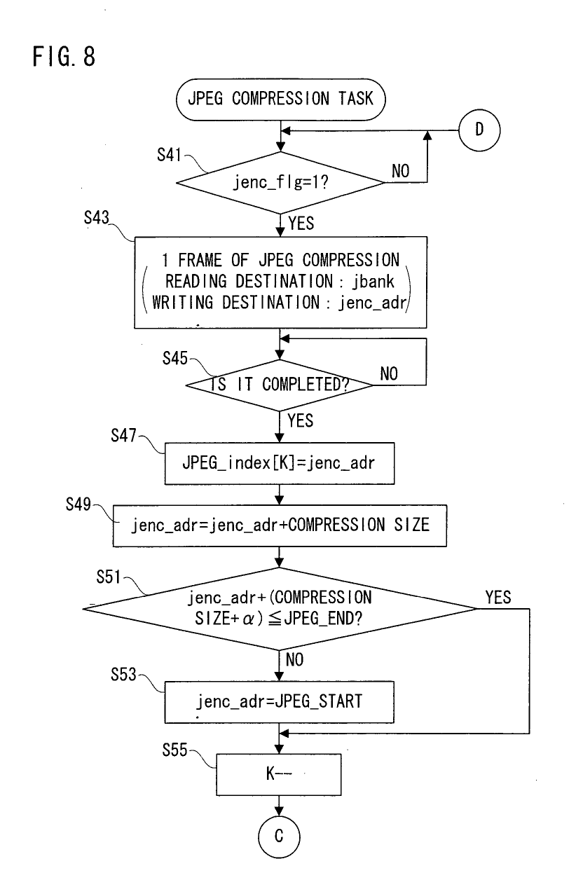

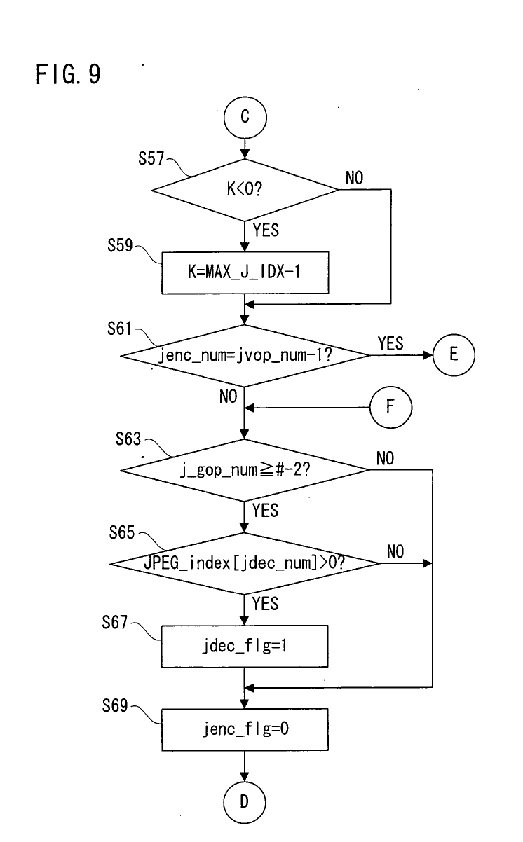

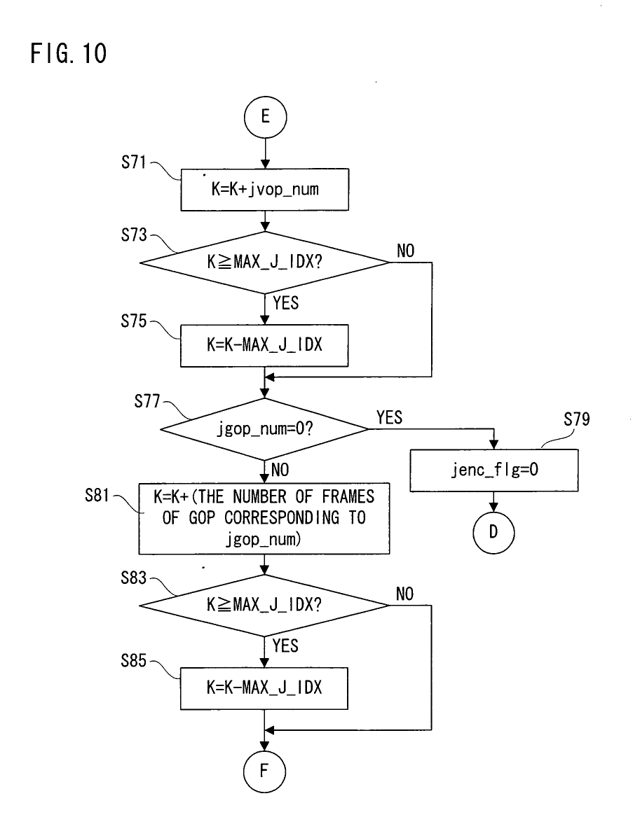

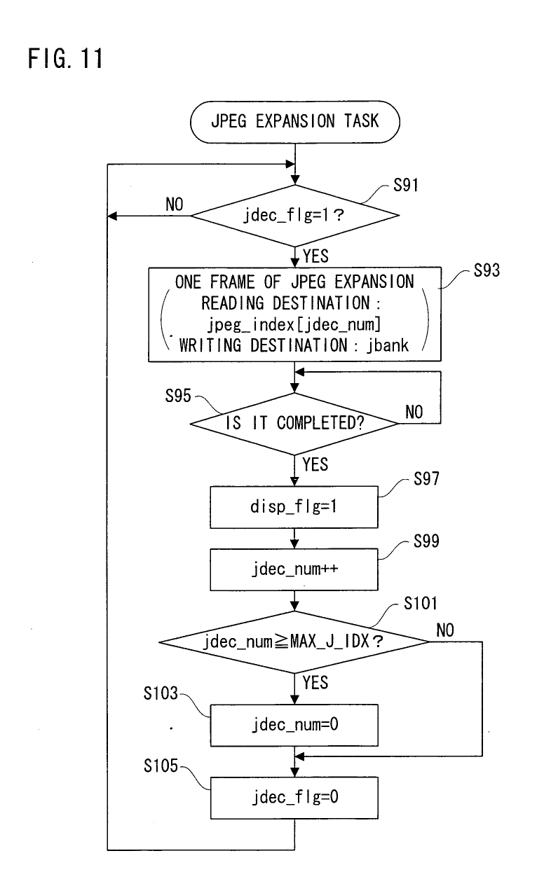

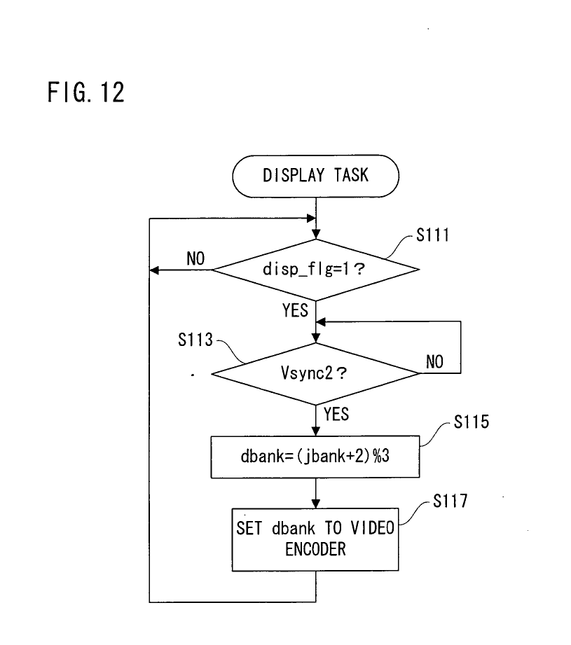

When the right direction is designated by the cursor key 36c during reproduction of the motion image in the forward direction, the motion image is reproduced in the reverse direction. At this time, the CPU 36 executes in parallel an MPEG expansion task shown in FIG. 6-FIG. 7, a JPEG compression task shown in FIG. 8-FIG. 10, a JPEG expansion task shown in FIG. 11, and a display task shown in FIG. 12.

Additionally, the CPU 36 executes the tasks shown in FIG. 6-FIG. 12 under the control of the multitasking OS, such as CITRON. The control programs corresponding to these tasks are stored in the flash memory 22.

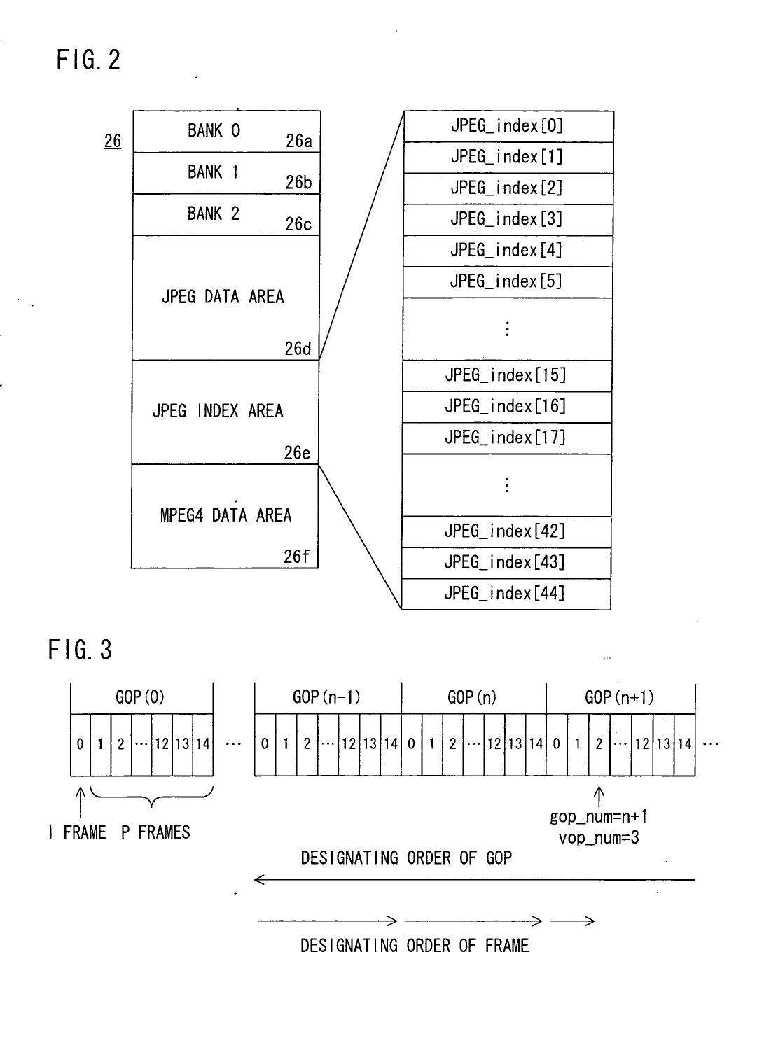

In the reproduction mode, the SDRAM 26 is mapped as shown in FIG. 2. Each of bank 26a (bank 0), bank 26b (bank 1), and bank 26c (bank 2) is an area for storing one frame of the expanded image data. The JPEG data area 26c is an area for storing each frame of the JPEG data. A JPEG index area 26e is an area for storing a start address value of each frame of the JPEG data stored in a JPEG data area 26d, and is made up of 45 columns, JPEG_index[0]-JPEG_index[44]. An MPEG4 data area 26f is an area for storing MPEG data read from the recording medium 44.

It should be noted that the transfer of the MPEG data from the recording medium 44 to the MPEG4 data area 26f is periodically executed by a task not shown.

Referring to FIG. 6, in a step S1, various variables are initialized. More specifically, the GOP number gop_num is set to “#”, and the frame count vop_num is set to “*”, the column number K is set to “vop_num−1”, and the address value jenc_adr is set to “JPG_START”. In addition, each of flags mdec_end, jenc_flg, jdec_flg and disp_flg is set to “0”, and each of frame numbers mdec_num, jenc_num, and jdec_num is set to “0”, and each of bank numbers mbank, jbank and dbank is set to “0”.

Here, the GOP number gop_num is an identification number of a notable GOP, “#” is an identification number of the GOP to which the frame reproduced at a time when a motion image reproduction in the reverse direction is instructed belongs. The frame count vop_num is the number of frames to be reproduced from the notable GOP, and the “*” indicates a value obtained by adding “1” to the frame number reproduced at a time when a motion image reproduction in the reverse direction is instructed.

In a case that a reproduction in the reverse direction is started from the frame to which the frame number of “2” is assigned out of 15 frames belonging to GOP(n+1) shown in FIG. 3, “#” denotes “n+”, and “*” denotes “3”.

The column number K is an identification number of the column formed in the JPEG index area 26e shown in FIG. 2. The address value jenc_adr is a value of an address from which writing of the JPEG data is started, and the “JPG_START” is a start address value of the JPEG data area 26d.

The flag mdec_end is a flag for determining whether or not a reproduction frame reaches a start frame of the MPEG file. Then, “0” means that the reproduction frame has not reached, and “1” means that the reproduction frame has already reached. The flag jenc_flg is a flag for determining whether or not compression processing by the JPEG codec 40 is allowed. Then, “0” means prohibition, and “1” means allowance. The flag jdec_flg is a flag for determining whether or not expansion processing by the JPEG codec 40 is allowed. Here, “0” means prohibition, and “1” means allowance. The flag disp_flg is a flag for determining whether or not encoding processing by the video encoder 28 is allowed. Here, “0” means prohibition, and “1” means allowance.

The frame number mdec_num is an identification number of the frame to be expanded by the MPEG 4 codec 38. The frame number jenc_num is an identification number of the frame to be compressed by the JPEG codec 40. The frame number jdec_num is an identification number of the frame to be expanded by the JPEG codec 40.

The bank number mbank is an identification number of a bank in which one frame of image data expanded by the MPEG 4 codec 38 is stored. The bank number jbank is an identification number of the bank in which one frame of image data to be compressed by the JPEG codec 40 is stored, or the bank to which one frame of image data expanded by the JPEG codec 40 is stored. The bank number dbank is an identification number of the bank in which one frame of image data to be displayed on the LCD monitor 30 is stored.

In a step S3, it is determined whether or not a vertical synchronization signal Vsync 1 is generated, and if “YES”, it is determined whether or not the flag mdec_end is “1” in a step S5. If mdec_end=0, the process proceeds to a step S9 and the onward. If mdec_end=1, the flag jdec_flg is set to “1” in a step S7, and then, the process returns to the step S3.

Additionally, the flag mdec_end is set to “1” in a step S37 described later when the reproduction frame has reached the start frame of the MPEG file. Also, the step S7 is a step for setting the flag jdec_flg to “1” in place of a step S69 described later after the JPEG compression of the start frame of the MPEG file is completed.

In the step S9, the frame number mdec_num is set to the frame number jenc_num. In a step S11, the frame count vop_num is set to the frame count jvop_num, and in a step S13, the GOP number gop_num is set to the GOP number jgop_num, and in a step S15, the bank number mbank is set to the bank number jbank.

The frame number mdec_num, the frame count vop_num, the GOP number gop_num, and the bank number mbank are referred in the MPEG expansion task, and the frame number jenc_num, the frame count jvop_num, the GOP number jgop_num, and the bank number jbank are referred in the JPEG compression task. The process from the steps S9 to S15 is for maintain synchronization between mutually related parameters. Also, as clarified from the process in the step S1, the process in the step S9 at a first cycle is useless.

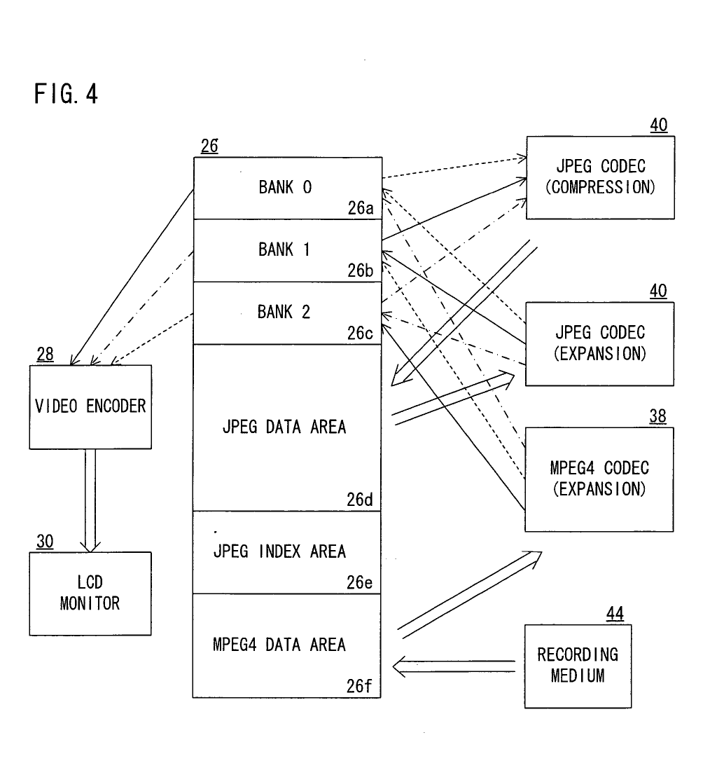

In a step S17, an expansion instruction of one frame is issued to the MPEG 4 codec 38. The issued expansion instruction includes the GOP number gop_num, the frame number mdec_num, and the bank number mbank. The MPEG 4 codec 38 reads one frame of MPEG data designated by the GOP number gop_num and the frame number mdec_num from the MPEG4 data area 26f shown in FIG. 4, expands the read MPEG data, and writes the expanded image data to a bank corresponding to the bank number mbank out of the banks 0-2 shown in FIG. 4.

After completion of the expansion processing, “YES” is determined in a step S119, and the flag jenc_flg is set to “1” in a step S21. Thus, the process in a step S43 and the onward shown in FIG. 8 is started. In a step S23, a bank number mbank is updated according to the equation 1. According to the equation 1, a remainder obtained by dividing “mbank+1” by “3” is set as a bank number mbank.
mbank=(mbank+1)%3 [Equation 1]

In a step S25, the frame number mdec_num is incremented, and in a step S27, it is determined whether or not the incremented frame number mdec_num is coincident with the frame count vop_num. If “NO” here, the MPEG expansion of the frame to be reproduced from the notable GOP has not yet been completed, and the process directly returns to the step S3.

On the contrary thereto, if “YES” in the step S27, the GOP number gop_num is decremented in a step S29 in order to change the notable GOP. It is determined whether or not the decremented GOP number gop_num is below “0” in a step S31.

If the GOP number gop_num is equal to or more than “0”, the process proceeds to a step S33 to set the frame count vop_num to the number of frames of the GOP corresponding to the GOP number gop_num. Then, in a step S35, “0” is set to the frame number mdec_num, and then, the process returns to the step S3. On the other hand, if the GOP number gop_num is less than “0”, the flag mdec_end is set to “1” in the step S37 in order to end the MPEG expansion processing. After completion of the process in the step S37, the process returns to the step S3.

Through an execution of the MPEG expansion task, as shown in FIG. 3, a plurality of GOPs forming the MPEG data are designated in the reverse direction in turn, and a plurality of frames forming the designated GOP is designated in a forward direction. The MPEG 4 codec 38 performs expansion processing on the frames thus designated. The expanded image data is written to each of the banks 0-2, that is, from the bank 0, bank 1, bank 2, bank 0 . . . in this order.

With reference to FIG. 8, in a step S41, it is determined whether or not the flag jenc_flg denotes “1”, and if “YES”, the process proceeds to a step S43. As described above, the flag jenc_flg is updated to “1” in the step S21 after completion of the MPEG expansion in the first cycle of the process. Thus, the process in the step S43 and the onward is started at a time when one frame of image data is held in the bank corresponding to the bank number mbank.

In the step S43, a compression instruction is issued to the JPEG codec 40. The issued compression instruction includes the bank number jbank (=mbank) and the address value jenc_adr. The JPEG codec 40 reads one frame of image data from the bank corresponding to the bank number jbank out of the banks 0-2 shown in FIG. 4, performs a JPEG compression on the read image data, and writes the generated JPEG data to an address corresponding to the address value jenc_adr and the onward in the JPEG data area 26d shown in FIG. 4.

After completion of the JPEG compression, “YES” is determined in a step S45, and in a step S47, the address value jenc_adr is written to the column JPEG_index [K] of the JPEG index area 26e shown in FIG. 2. In a step S49, the address value jenc_adr is updated according to the equation 2, and it is determined whether or not a condition of the equation 3 is satisfied in a step S81.
jenc_{—}adr=jenc_{—}adr+compressed size [Equation 2]
jenc_{—}adr+(compressed size+α)≦JPEG_END [Equation 3]

Additionally, “compressed size” shown in the equation 2 and equation 3 is a size of the JPEG data created by the process in the immediately preceding step S43. Also, “JPEG_END” is an end address value of the JPEG data area 26d shown in FIG. 2, and “α” is a margin.

When the condition of the equation 3 is satisfied, the process directly proceeds to a step S55. On the contrary thereto, when the condition of the equation 3 is not satisfied, the address value jenc_adr is set to “JPEG_START” in a step S53, and then, the process proceeds to the step S55. In the step S55, the column number K is decremented, and in a succeeding step S57, it is determined whether or not the column number K is below “0”. If the column number K is equal to or more than “0”, the process directly proceeds to a step S61. On the other hand, if the column number K is less than “0”, the column number K is set to “MAX_J_IDX−1” in a step S59, and then, the process proceeds to a step S61.

Here, “MAX_J_IDX” is a total number of the columns formed in the JPEG index area 26d. As can be understood from FIG. 2, in this embodiment, “MAX_J_IDX” denotes “45”.

In the step S61, it is determined whether or not the frame number jenc_num is coincident with “jvop_num−1”. That is, it is determined whether or not the frame on which the JPEG compression is performed is an end frame to be reproduced from the notable GOP. If “NO” here, it is determined whether or not the GOP number jgop_num is equal to or more than “#-2” in a step S63, and it is determined whether or not the address value written to the column JPEG_index[jdec_num] exceeds “0” in a step S65.

The step S63 is a step for determining whether or not JPEG data of a sufficient number of frames is accumulated in the JPEG data area 26d. The step S65 is a step for determining whether or not an effective address value is set to the column JPEG_index[jdec_num].

If “NO” is determined in any one of the steps S63 and S65, the process directly proceeds to a step S69. If “YES” is determined in both the steps S65 and S67, “1” is set to the flag jdec_flg in the step S67, and the process proceeds to the step S69. By the process in the step S67, the process in the step S93 shown in FIG. 11 and the onward is started. In the step S69, the flag jenc_flg is set to “0” in order to prohibit the JPEG compression processing, and then, the process returns to the step S41.

If “YES” is determined in the step S61, the column number K is set to “K+jvop_num” in a step S71, and it is determined whether or not the updated column number K is equal to or more than “MAX_J_IDX” in a step S73. If “NO” here, the process directly proceeds to a step S77, and if “YES”, the variable K is updated to “K−MAX_J_IDX” in a step S75, and then, the process proceeds to the step S77. Thus, the columns formed in the JPEG index area 26e circularly designated.

In the step S77, the GOP number jgop_num is decremented, and in a step S81, it is determined whether or not the updated GOP number jgop_num is “0”. If “YES” is determined here, the flag jenc_μg is set to “0” in a step S79, and then, the process returns to the step S41.

On the other hand, if “NO” is determined in the step S77, the process in the step S81 and the onward is executed. In the step S81, the number of frames of the GOP corresponding to the GOP number jgop_num is added to the column number K, and the column number K is updated with the added value thus obtained. In a step S83, it is determined whether or not the updated column number K is equal to or more than “MAX_J_IDX”. If “NO”, the process directly shifts to the step S63, and if “YES”, the column number K is updated with the “K−MAX_J_IDX” in a step S85, and the process shifts to the step S63.

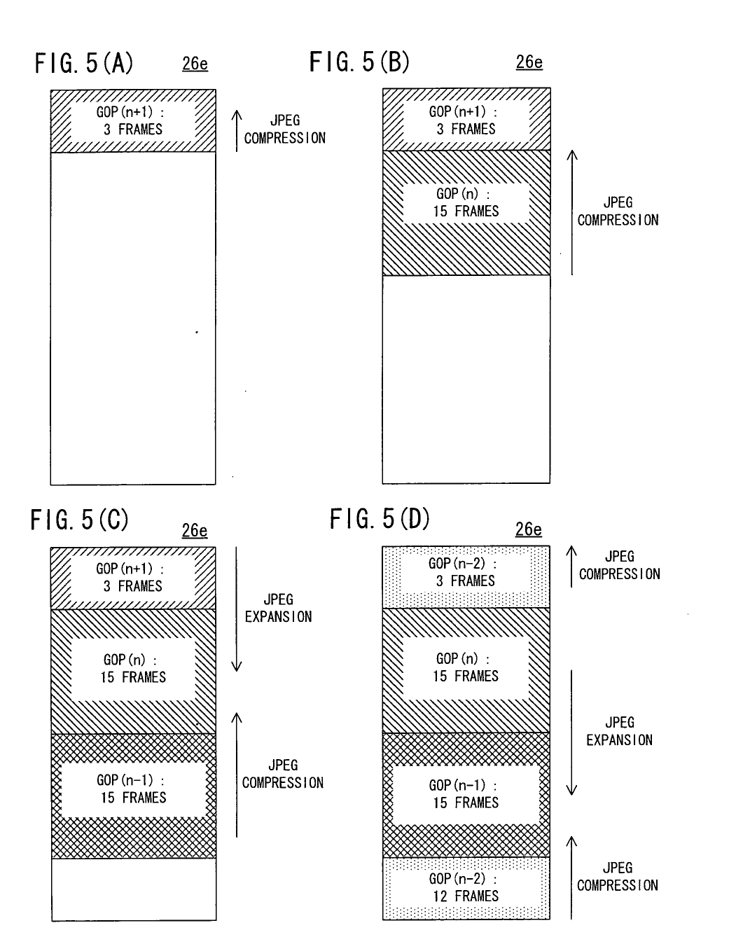

By the JPEG compression task, each frame of image data expanded in the forward direction from each GOP designated in the reverse direction is subjected to a JPEG compression in the forward direction. Each frame of the JPEG data thus obtained is written to the JPEG data area 26d. Furthermore, a start address value of each frame of JPEG data is written to the JPEG index area 26e in a manner shown in FIG. 5 (A)-FIG. 5 (D).

When the JPEG index area 26e is noted, three start address values relating to three frames of GOP(n+1) are respectively written to columns JPEG_index[2]-JPEG_index[0] in a manner shown in FIG. 5 (A). Next, 15 start address values relating to 15 frames of GOP (n) are respectively written to columns JPEG_index[17]-JPEG_index [3] in a manner shown in FIG. 5 (B).

When a JPEG compression relating to GOP (n−1) is started, “YES” is determined in the step S63 (and S65), and the flag jdec_flg is set to “1” in the step S67. That is, an expansion processing of the JPEG data is allowed. A start address value stored in the JPEG index area 26e is read by the JPEG expansion task described later in a manner shown in FIG. 5 (C) and FIG. 5 (D).

Out of 15 start address values relating to 15 frame of GOP(n−2), the three start address values from the top are respectively written to JPEG_index [2]-JPEG_index [0], and the rest of 12 start address values are written to the JPEG_index [44]-JPEG_index [32] (see FIG. 5(D)).

With reference to FIG. 11, it is determined whether or not the flag jdec_flg denotes “1” in a step S91, and if “YES”, one frame of expansion instruction is issued to the JPEG codec 40 in a step S93. The expansion instruction includes the address value written to the column jpeg_index[jdec_num] and the bank number jbank. The JPEG codec 40 reads one frame of JPEG data from the JPEG data area 26e according to the address value included in the expansion instruction, expands the read JPEG data, and writes the expanded image data to the bank corresponding to the bank number jbank.

After completion of such a JPEG expansion process, “YES” is determined in a step S95, and the flag disp_flg is set to “1” in a step S97, and a column number jdec_num is incremented in a step S99. In a step S101, it is determined whether or not the updated column number jdec_num is equal to or more than “MAX_J_IDX”. If “NO” here, the process directly proceeds to a step S1105, and if “YES”, the column number jdec_num is set to “0” in a step S103, and then, the process proceeds to the step S105. In the step S105, the flag jdec_μg is set to “0”, and then, the process returns to the step S91.

By such a JPEG expansion task, a start address value of each frame of JPEG data is read from the JPEG index area 26d in a manner shown in FIG. 5 (A)-FIG. 5 (D).

With reference to FIG. 12, it is determined whether or not the flag disp_flg is “1” in a step S111. If “YES” here, generation of a vertical synchronization signal Vsync 2 is waited in a step S113, and then, the bank number dbank is updated according to the equation 4 in a step S115. According to the equation 4, the remainder obtained by dividing “jbank+2” by “3” is set as a bank number dbank.
dbank=(jbank+2)% 3 [Equation 4]

In a step S117, the updated bank number dbank is set to the video encoder 28, and then, the process returns to the step S111.

By such a display task, the banks 0-2 shown in FIG. 2 are circularly designated, and a motion image moving in the reverse direction is displayed on the LCD monitor 30.

As understood from the above description, each of the plurality of GOPs includes image data of a plurality of frames in which a start frame in a forward direction is subjected to intra-encoding, and the frame successive to the start frame in the forward direction is subjected to inter-encoding. The CPU 36 designates in turn such a plurality of GOP blocks in the reverse direction (S29). The MPEG 4 codec 38 decodes the plurality of frames of image data included in the designated GOP in the forward direction, and the JPEG codec 40 performs intra-encoding on the decoded image data of each of the plurality of frames in the forward direction. The CPU 36 determines whether or not the number of frames on which the intra-encoding is performed is equal to or more than a threshold value (S63). When the determination result by the CPU 36 is affirmative, the JPEG codec 40 decodes in the reverse direction image data of the plurality of frames on which the intra-encoding was performed.

That is, the image data decoded by the MPEG 4 codec 38 in the forward direction is subjected to intra-encoding in the forward direction by the JPEG codec 40. The image data on which the intra-encoding was performed is then decoded by the JPEG codec 40 in the reverse direction. By employing the intra-encoding, it is possible to reproduce the image data in the reverse direction while reducing a circuit dimension.

Additionally, in this embodiment, a JPEG system is employed for intra-encoding of each frame of image data, but a JPEG2000 system may be employed in place of the JPEG system.

Although the present invention has been described and illustrated in detail, it is clearly understood that the same is by way of illustration and example only and is not to be taken by way of limitation, the spirit and scope of the present invention being limited only by the terms of the appended claims.

1: An image processing apparatus, comprising:
a designating means for designating a plurality of blocks each including a plurality screen of image data in which a top screen in a first-time-axis direction is subjected to intra-encoding and a screen successive to said top screen in said first-time-axis direction is subjected to inter-encoding in turn along a second-time-axis direction reverse to said first-time-axis direction;
a first decoding means for decoding the plurality of screens of image data included in the block designated by said designating means in turn along said first-time-axis direction;
an encoding means for performing intra-encoding along said first-time-axis direction on each of the plurality of screens of the image data decoded by said first decoding means; and
a second decoding means for decoding the plurality of screens of the image data encoded by said encoding means in turn along said second-time-axis direction.

2: An image processing apparatus according to claim 1, further comprising a determining means for determining whether or not the number of screens on which said intra-encoding is performed is equal to or more than a threshold value, wherein said second decoding means performs a decoding process when a determination result by said determining means is affirmative.

3: An image processing apparatus according to claim 1, wherein each of said encoding means and said second decoding means complies with a JPEG system.

4: An image processing apparatus according to claim 1, wherein said first-time-axis direction is a forward direction, and said second-time-axis direction is a reverse direction.

5: An image processing program executed by a processor of an image processing apparatus, comprising:
a designating step for designating a plurality of blocks each including a plurality screen of image data in which a top screen in said first-time-axis direction is subjected to intra-encoding, and a screen successive to said top screen in a first-time-axis direction is subjected to inter-encoding in turn along a second-time-axis direction reverse to said first-time-axis direction;
a first decoding step for decoding the plurality of screens of image data included in the block designated by said designating step in turn along said first-time-axis direction;
an encoding step for performing intra-encoding along said first-time-axis direction on each of the plurality of screens of the image data decoded by said first decoding step; and
a second decoding step for decoding the plurality of screens of the image data encoded by said encoding step in turn along said second-time-axis direction.

6: An image processing apparatus, comprising:
a processor for designating a plurality of blocks each including a plurality screen of image data in which a top screen in a first-time-axis direction is subjected to intra-encoding, and a screen successive to said top screen in said first-time-axis direction is subjected to inter-encoding in turn along a second-time-axis direction reverse to said first-time-axis direction;
a decoder for decoding in turn the plurality of screens of the image data included in the block designated by said processor in turn along said first-time-axis direction; and
a codec for performing intra-encoding along said first-time-axis direction on each of the plurality of screen of the image data decoded by said decoder, and decoding the plurality of screens of the image data on which said intra-encoding is performed in turn along said second-time-axis direction.

7: An image processing apparatus according to claim 6, wherein said processor alternately instructs said codec to perform an encoding process and a decoding process, and said codec executes a process according to an instruction from said processor.

8: An image processing apparatus according to claim 2, wherein each of said encoding means and said second decoding means complies with a JPEG system.

9: An image processing apparatus according to claim 2, wherein said first-time-axis direction is a forward direction, and said second-time-axis direction is a reverse direction.

10: An image processing apparatus according to claim 3, wherein said first-time-axis direction is a forward direction, and said second-time-axis direction is a reverse direction.

11: An image processing apparatus according to claim 8, wherein said first-time-axis direction is a forward direction, and said second-time-axis direction is a reverse direction.
